(19) United States
(12) Patent Application Publication
(10) Pub. No.: US 2025/0189551 A1
(43) Pub. Date: Jun. 12, 2025

(54) PIPETTE DISPOSAL GUIDE FOR A LIQUID HANDLING SYSTEM

(71) Applicant: Revvity Cellular Technologies GmbH, Hamburg (DE)

(72) Inventor: Roland Stange, Hamburg (DE)

(21) Appl. No.: 18/533,591

(22) Filed: Dec. 8, 2023

(51) Int. Cl. G01N 35/10

(52) U.S. Cl. CPC G01N 35/1009; G01N 2035/103

(57) ABSTRACT

A pipette tip disposal guide includes an elongated body having an upper first end and an opposite, lower second end, and a major surface extending between the first and second ends, the second end being configured to be positioned adjacent the pipette tip disposal for an automated liquid handling system. The major surface comprises a contact-reducing structure and is configured to receive a pipette tip such that the pipette moves toward the lower second end to the pipette tip disposal.

### FIELD

The present disclosure relates to liquid handling systems, and in particular, to a pipette disposal guide for a liquid handling system.

### BACKGROUND

Liquid handling systems typically incorporate automated pipetting systems to transfer liquid between containers, such as microplate vials, for high throughput assays. After a pipette is used to transfer liquid, the pipette tips need to be removed from the liquid handling system quickly and efficiently.

Liquid handling systems may incorporate a pipette disposal guide or chute that enables the pipette to be dropped into the chute and transported away from the instrument to a disposal area. However, due to liquids on the tips and/or the wetted surface of the chute from contacting used tips, the lightweight tips may stick on the chute surface and block the chute. Due to the large number of tips that may be used in an automated liquid handling system, user intervention may be required to clear the chute, and the entire automated liquid handling system may experience disruptions in use due to the blocked chute.

### SUMMARY OF SOME EMBODIMENTS

According to some embodiments, an automated liquid handling system includes a pipette tip disposal guide configured to guide pipette tips to a pipette tip disposal comprising. The liquid handling system includes a probe with a removable pipette tip configured to collect and expel liquid samples; a pipette tip disposal configured to receive the pipette tip when the pipette tip is removed from the probe; and a pipette tip disposal guide configured to guide the pipette tip into the pipette tip disposal. The pipette tip disposal guide includes an elongated body having an upper first end and an opposite, lower second end, and a major surface extending between the first and second ends, the second end being configured to be positioned adjacent the pipette tip disposal for an automated liquid handling system. The major surface comprises a contact-reducing structure and is configured to receive a pipette tip such that the pipette moves toward the lower second end to the pipette tip disposal.

In some embodiments, the pipette tip disposal guide includes a plurality of rods extending horizontally along the elongated body, and the contact-reducing structure of the major surface is provided by top portions of the plurality of rods.

In some embodiments, the pipette tip disposal guide includes first and second side walls on an outer side edge of the elongated body between the first and second ends, and the plurality of rods are mounted on the first and second side walls.

In some embodiments, the contact-reducing structure comprises a hydrophobic surface.

In some embodiments, the plurality of rods are polytetrafluoroethylene (PTFE) rods.

In some embodiments a polytetrafluoroethylene (PTFE) coating is on the plurality of rods.

In some embodiments, the elongated body further includes a floor below the plurality of rods, wherein the rods are spaced apart such that fluid from the pipette tips flows between the rods.

In some embodiments, a diameter of each of the plurality of rods is between 0.5 mm and 8 mm.

In some embodiments, the contact-reducing structure of the major surface comprises a lotus effect structure.

In some embodiments, the pipette disposal guide further includes a plurality of overlapping plates, and top portions of the overlapping plates provide the contact-reducing structure of the major surface.

In some embodiments, each of the plurality of overlapping plates include an edge positioned on a next one of the plurality of overlapping plates, and the edge includes a wave pattern.

In some embodiments, the edge has a convex shape.

In some embodiments, the major surface comprises an upper portion and a lower portion, and a slope angle of the upper portion is greater than a slope angle of the lower portion.

According to some embodiments, a pipette tip disposal guide includes an elongated body having an upper first end and an opposite, lower second end, and a major surface extending between the first and second ends, the second end being configured to be positioned adjacent the pipette tip disposal for an automated liquid handling system. The major surface comprises a contact-reducing structure and is configured to receive a pipette tip such that the pipette moves toward the lower second end to the pipette tip disposal.

According to some embodiments, a method of disposing of a pipette tip in a pipette tip disposal of an automated liquid handling system includes removing a pipette tip from a probe in an automated liquid handling system and positioning the pipette tip on a pipette tip disposal guide; guiding the pipette tip into the pipette tip disposal with a pipette tip disposal guide; and moving the pipette tip toward the lower second end of the pipette tip disposal guide and into the pipette tip disposal.

### BRIEF DESCRIPTION OF THE DRAWINGS

The accompanying drawings, which are incorporated in and constitute a part of the specification, illustrate some embodiments and, together with the description, serve to explain principles of the disclosure.

FIGS. 1-2 are perspective views of a liquid handling system having a pipette disposal guide according to some embodiments.

FIG. 3 is a perspective view of the pipette disposal guide of FIGS. 1-2.

FIG. 4 is a side cross-sectional view of the pipette disposal guide of FIG. 3.

FIG. 5A is a perspective view of a liquid handling system having a pipette disposal guide according to some embodiments.

FIG. 5B is a perspective view of the pipette disposal guide of FIG. 5A

FIG. 6 is a side cross sectional view of the pipette disposal guide of FIG. 5.

FIG. 7 is an exploded, side cross-sectional view of a portion of the pipette disposal guide of FIG. 6.

FIG. 8 is a flowchart illustrating methods according to some embodiments.

### DETAILED DESCRIPTION

The inventors have recognized and appreciated that, in a liquid handling system, there is a need for reducing the blockages of the pipette disposal guide to increase efficiencies and reduce workflow interruptions.

The inventors have further recognized and appreciated that, in a liquid handling system, streamlining movement of the pipette tips in the disposal guide and reducing friction between the pipette tips and the disposal guide may reduce disposal guide blockages.

Embodiments of the pipette disposal guide described herein may be used with any suitable liquid handling system, including commercially available liquid handling systems, such as The Sciclone® liquid handling system and the Opera Phenix® liquid handling system, both available from Revvity, Inc. (Waltham, MA).

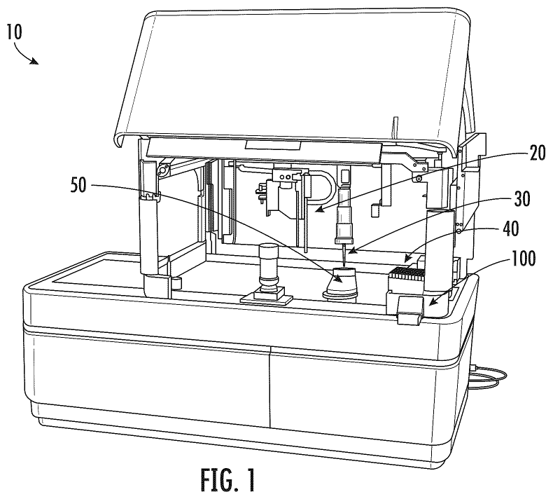

As illustrated in FIG. 1, a liquid handling system 10 includes a probe 20, a removable pipette tip 30, vials or containers 40, and an optional receptacle 50 for an analytical devices or sample analyzer. The liquid handling system 10 also includes a pipette tip disposal guide 100 and a pipette tip disposal, which is shown in FIG. 2 (pipette disposal 60). The probe 20 may be a robotically controlled probe for controlling movement of the pipette tip 30 to collect a liquid, to expel the liquid, and to move liquids between containers 40 or to the receptacle 50.

The pipette tip 30 may be configured to accurately collect a predetermined volume of liquid, such as water, solvents, acids, bases, or liquid reagents. For example, the pipette tip may be configured to collect between about 0.1 μL and 200 μL to within about 5% accuracy. The probe 20 and pipette tip 30 may be used to mix and deliver liquid samples and reagents, including samples having biological components such as cells or cell components, for processing high throughput assays and/or for delivering samples or sample solutions to analytical equipment via the receptacle 50. The pipette tip 30 and pipette tip disposal guide 100 may be sized and configured to operate as described herein using various liquids, including liquids having a range of viscosity from low viscosity fluids such as water to higher viscosity fluids, including pipette buffers or other liquids containing glucose, blood serum (e.g., bovine blood serum) or other high viscosity and “sticky” liquid materials.

After the pipette tip 30 has been used to collect, transport, and expel a liquid sample and/or reagent, the probe 20 is moved by the robotic arm to the pipette tip disposal guide 100. As shown in FIG. 2, the pipette tip disposal 60 is on or adjacent the liquid handling system and is configured to receive the pipette tip 30 when the pipette tip 30 is removed or released from the probe 20. The pipette tip disposal guide 100 is configured to guide the pipette tip 30 into the pipette tip disposal 60.

The pipette tip disposal guide 100 includes an elongated body 102 having an upper end 104 and an opposite, lower end 106, and a major surface 108 extending between the upper end 104 and the lower end 106. The lower end 106 is configured to be positioned adjacent the pipette tip disposal 60 of the automated liquid handling system 10 (FIG. 1). The major surface 108 has a contact-reducing structure 110. Two side walls 120 are on outer side edges of the elongated body 102 and extend between the upper end 104 and the lower end 106.

In use, the major surface 108 is configured to receive the pipette tip 30 such that the pipette tip 30 moves along the elongated body 102 toward the lower end 106 to the pipette tip disposal 60 (FIG. 1). As illustrated in FIGS. 1-4, the contact-reducing structure 110 is provided by rods 112 that extend horizontally along the elongated body 102. In some embodiments, the rods 112 include top portions 114 that include a hydrophobic material and are sized and shaped to provide the contact-reducing structure to reduce adhesion of the pipette tips 30 on the surface of the rods 112. The rods 112 are above a lower floor or planar member 130 that extends between the upper end 104 and the lower end 106 of the elongated body 102.

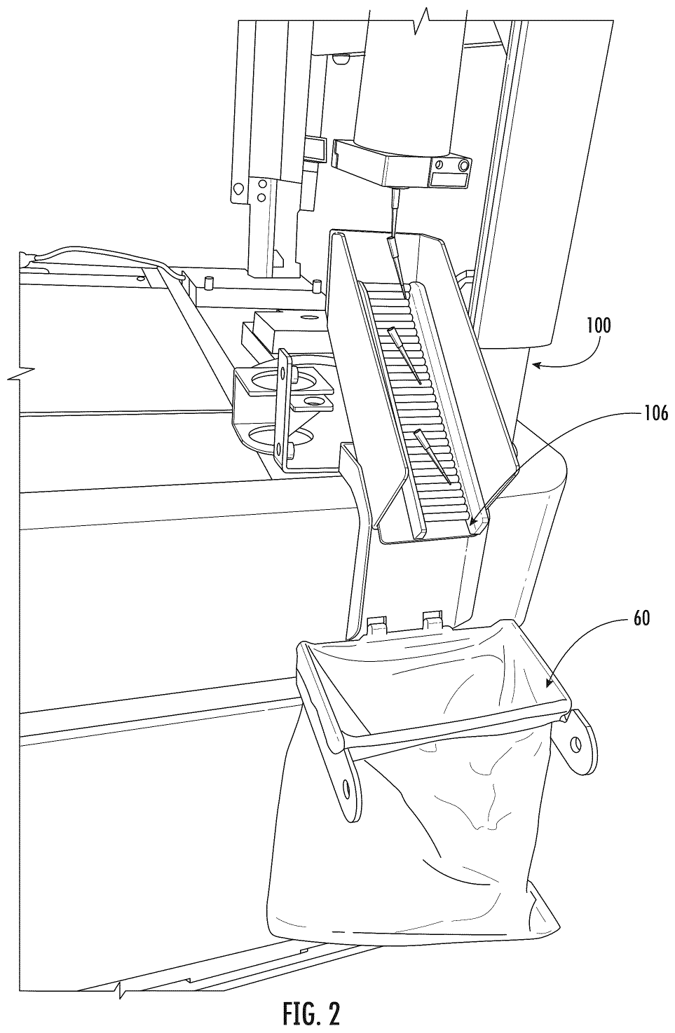

The contact-reducing structure 110 may reduce contact between the contact-reducing structure 110 and the pipette tips 30 to facilitate movement of the pipette tips 30, for example, because the pipette tips 30 contact the uppermost, rounded top portions 114 of the rods 112 and do not have contact with the regions between the top portions 114. Accordingly, the contact-reducing structure 110 may reduce friction or sticking of the pipette tip 30 on the elongated body 102 and reduce blockages of pipette tip disposal guide 100. In some embodiments, the contact-reducing structure 110 may facilitate sliding along the major surface 108 and reduce chaotic motion or rotation of the pipette tip 30 as it moves from the upper end 104 to the lower end 106 of the elongated body 102. For example, as illustrated in FIG. 3, when a pipette tip 30A is dropped into the pipette tip disposal guide 100, the pipette tip 30A may be misaligned with respect to a direction D defined by the elongated body 102. As the pipette tip moves towards the lower end 106 of the elongated body 102, the contact-reducing structure 110 may facilitate rotation of the pipette tip so that the pipette tip has a higher degree of alignment with the direction D as shown by pipette tip 30B in FIG. 3. In contrast, in the absence of the contact-reducing structure 110, the pipette tips 30 may have a higher misalignment with the direction D and be more likely to stick or adhere to the surface, which may increase blockages of the pipette tip disposal guide 100.

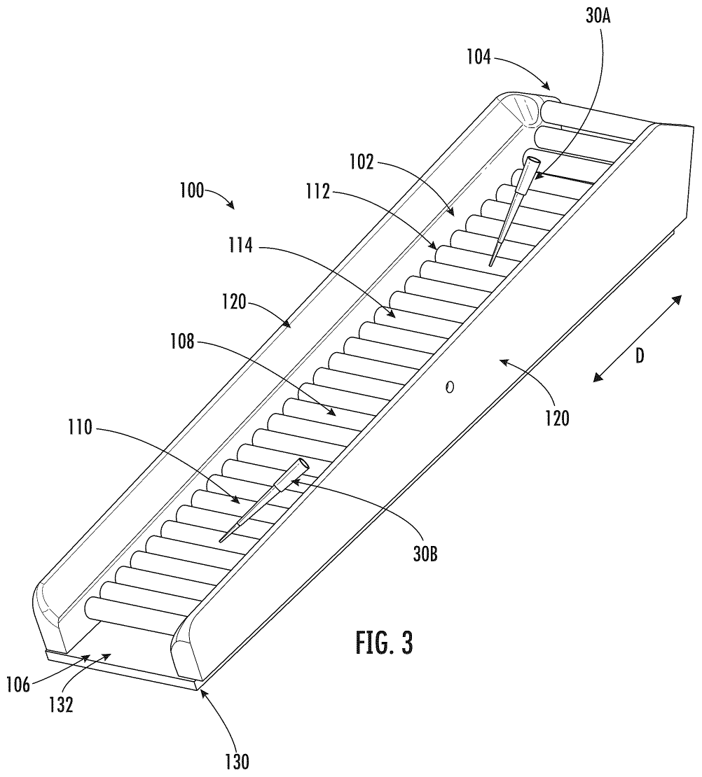

As illustrated, the rods 112 are mounted on the side walls 120, and the rods 112 are spaced apart from the lower planar member 130 by a space or void 132. In some embodiments, the rods 112 may be spaced apart from one another. Although the rods 112 may be mounted in any suitable configuration, as illustrated in FIGS. 3-4, the space or void 132 between the rods 112 and the lower planar member 130 may permit fluids that accumulate on the rods 112 to flow downward between the rods 112 and onto the lower planar member 130. Due to the slope of the planar member 130, fluids from the rods 112 may then flow through the space or void 132 towards the lower end 106 of the elongated body 102 and exit the pipette tip disposal guide 100. In this configuration, wetting of the contact-reducing surface 110 and adherence of the pipette tips 30 may be further reduced.

In some embodiments, the major surface 108 has a slope angle that is greater in an upper region or portion than at the lower region or portion. This variable slope may facilitate the entrance of the pipette tips 30 tangentially to the pipette tip disposal guide 100 and may reduce bouncing of the pipette tips on the pipette tip disposal guide 100.

Although the rods 112 may be formed of any suitable material and may have a hydrophobic surface, in some embodiments, the rods 112 may be formed of or partially formed of a fluoropolymer such as polytetrafluoroethylene (PTFE) or other hydrophobic material. Thus, the rods 112 may be polytetrafluoroethylene (PTFE) rods or polytetrafluoroethylene (PTFE)-coated rods (e.g., a non-hydrophobic material that is coated with a hydrophobic material such as a fluoropolymer (polytetrafluoroethylene (PTFE)). In some embodiments, the diameter of the rods 112 is between 0.5 mm and 8 mm. The diameter of the rods 112 may be about 4 mm. The diameter of the rod 112 is about 4 mm, but may be any suitable size. In some embodiments, the diameter may be adjusted to the slope angle of the tip disposal guide 100 so that for a steeper angle, larger diameter rods may be used. Although larger diameter rods 112 may be preferred, if the rods 112 are too large, the peak point of the pipette tip 30 may become lodged or stuck between the rods 112. The tip disposal guide 100 may have a starting slope angle at a top portion of about 60′ and an ending slope of about 30°-35° and a width of about 30 mm, a chute length of the disposal guide 100 of about 160 mm and a distance between the rods 112 and the bottom planar member 130 is about 3 mm. However, it should be understood that the above dimensions may be modified without departing from the scope of the invention. In a non-limiting example, the above dimensions may be modified by about 10% or 20%. Without wishing to be bound by any particular theory, the positioning of the pipette tip disposal guide 100 and the angle of the disposal guide 100 may impact the effectiveness of the pipette tip disposal guide 100. In some embodiments, a steeper slope at the upper end of the pipette tip disposal guide 100 as compared to the lower end of the pipette tip disposal guide 100 may facilitate pipette tip disposal and reduce blockages of the pipette tip disposal guide 100.

In some embodiments, the contact-reducing structure 110 may be a lotus effect structure. A lotus effect structure generally discourages surface wetting by having a waxy, nonpolar coating and a rough surface structure, which reduces surface wetting interactions and allows water to bead up into spheres on the surface of the lotus effect structure.

Although embodiments according to the present invention are described with respect to the rods 112 that provide the contact-reducing structure 110, it should be understood that any suitable configuration may be used as a contact-reducing structure in a pipette tip disposal guide, including saw tooth shaped structures, or periodic triangle shaped designs. Therefore, any suitable periodic geometry that forms a contact-reducing structure may be used. In addition, contact-reducing structures that are not hydrophobic may be used. Moreover, contact-reducing structures that include valleys (e.g. regions between the rods 112) that allow fluids to pass through and be removed from the structure may further reduce adhesion of the pipette tips 30 with the contact-reducing structure.

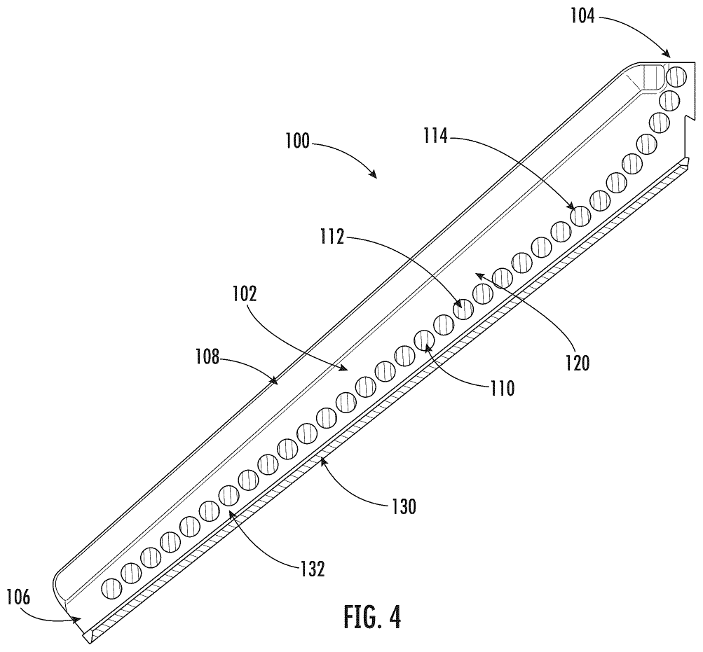

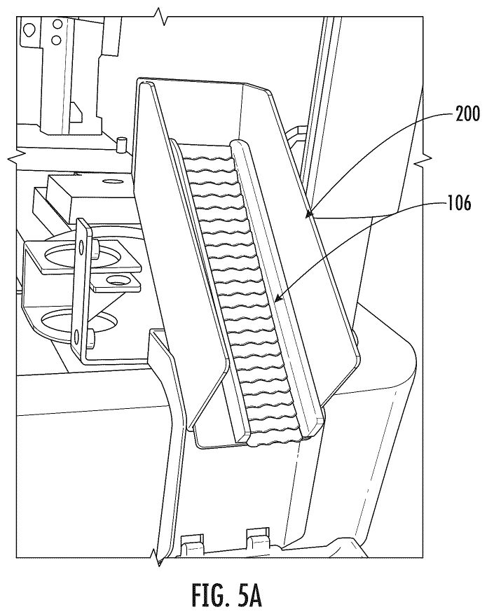

For example, as illustrated in FIGS. 5A-5B, 6-7, a pipette tip disposal guide 200 includes an elongated body 202 having an upper end 204 and an opposite, lower end 206, and a major surface 208 extending between the upper end 204 and the lower end 206 with a contact-reducing structure 210. Two side walls 220 are on outer side edges of the elongated body 202.

As illustrated, the contact-reducing structure 210 is provided by a series of overlapping plates 212 that extend horizontally along the elongated body 202, and the contact-reducing structure 210 is provided by top, exposed surfaces of the plates 212. The plates 212 may be mounted on the side walls 220 above a lower floor or planar member 230 that extends between the upper end 204 and the lower end 206 of the elongated body 202.

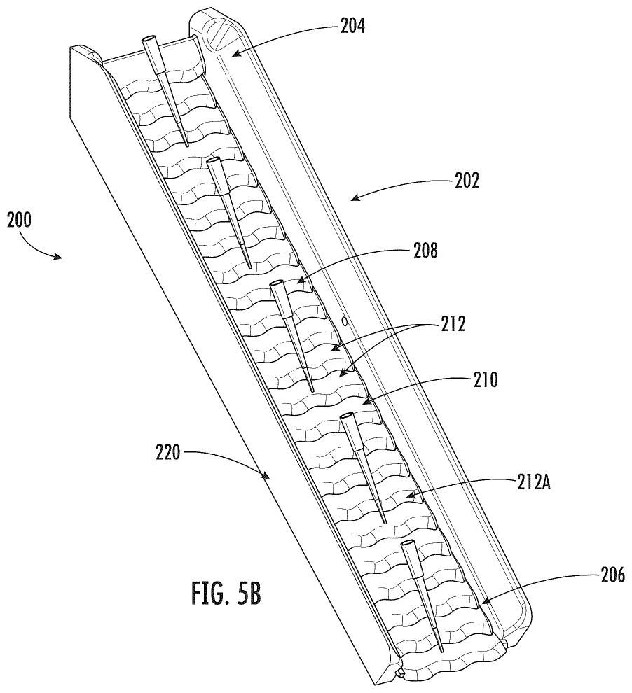

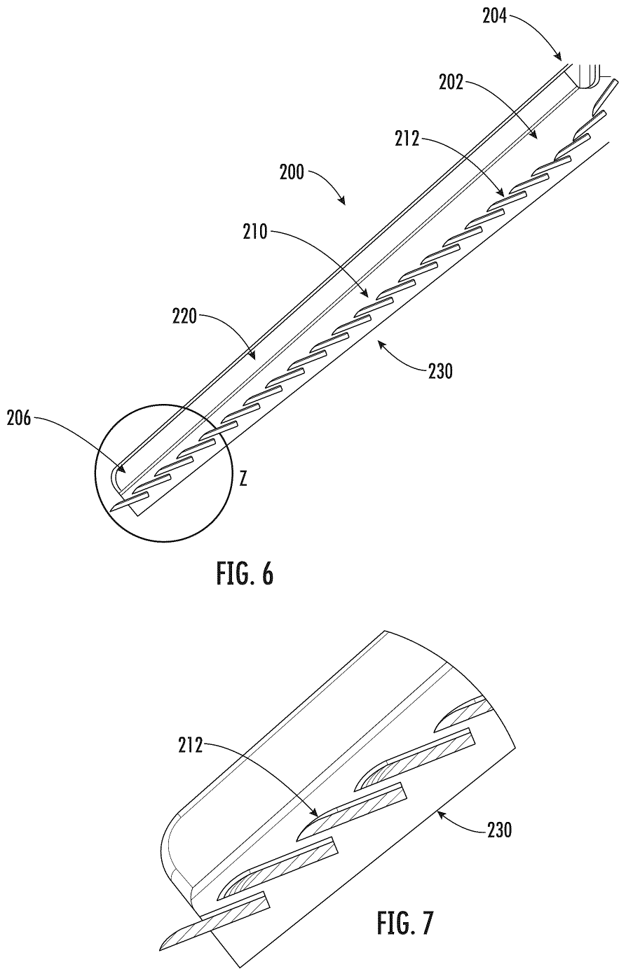

The overlapping plates 212 may each include an edge 212A positioned on a next lower one of the plates 212A, and the edge may be a wave pattern and/or a convex shape. As illustrated in FIGS. 6-7, the plates 212 may be spaced apart from the planar member 230 and the plates 212 may be spaced apart from one another so that any fluid from the pipette tips may flow between the plates 212 and down the planar member 230 towards the end 206.

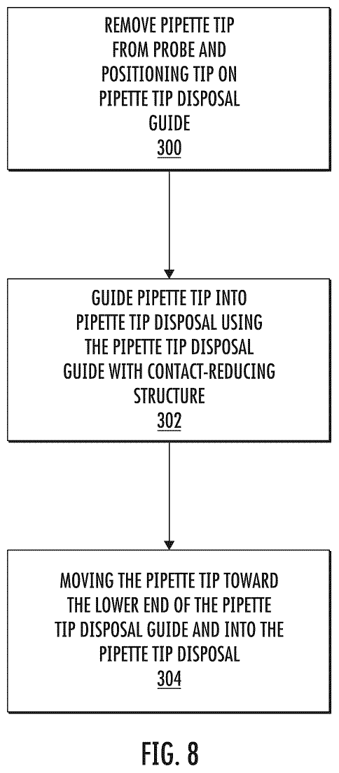

The pipette tip disposal guides described herein may be used according to the methods described in FIG. 8. In particular, the pipette tip may be removed from a prove and released so that it is positioned on the pipette tip disposal guide (Block 300). The pipette tip is guided into the pipette tip disposal using a pipette tip disposal guide with a contact-reducing structure. The contact-reducing structure may reduce contact between the pipette tip and pipette tip disposal guide and may reduce blockages of the pipette tip disposal guide (Block 320). The pipette tip is moved toward the lower end of the pipette tip disposal guide and into the pipette tip disposal (Block 304).

In some embodiments, the contact-reducing structure 110 may be inserted into an existing pipette tip disposal guide 100, including pipette tip disposal guides that are commercially available. The contact-reducing structure 110 or portions thereof may be manufactured using any suitable technique, including three-dimensional printing.

The present inventive concepts are described herein with reference to the accompanying drawings and examples, in which embodiments are shown. Additional embodiments may take on many different forms and should not be construed as limited to the embodiments set forth herein. Rather, these embodiments are provided so that this disclosure will be thorough and complete, and will fully convey the scope of the inventive concepts to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting thereof. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, for example, the term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The foregoing is illustrative of the present inventive concept and is not to be construed as limiting thereof. Although a few example embodiments have been described, those skilled in the art will readily appreciate that many modifications are possible in the example embodiments without materially departing from the novel teachings of this inventive concept. Accordingly, all such modifications are intended to be included within the scope of this inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims.

What is claimed is:

1. A pipette tip disposal guide for an automated liquid handling system comprising:
an elongated body having an upper first end and an opposite, lower second end, and a major surface extending between the first and second ends, the second end being configured to be positioned adjacent a pipette tip disposal for an automated liquid handling system;
wherein the major surface comprises a contact-reducing structure and is configured to receive a pipette tip such that the pipette moves toward the lower second end to the pipette tip disposal with reduced contact with the pipette tip disposal guide.

2. The pipette tip disposal guide of claim 1, further comprising a plurality of rods extending horizontally along the elongated body, wherein the contact-reducing structure of the major surface is provided by top portions of the plurality of rods.

3. The pipette tip disposal guide of claim 1, wherein the contact-reducing structure is hydrophobic.

4. The pipette tip disposal guide of claim 2, further comprising first and second side walls on an outer side edge of the elongated body between the first and second ends, wherein the plurality of rods are mounted on the first and second side walls.

5. The pipette tip disposal guide of claim 4, wherein the plurality of rods are polytetrafluoroethylene (PTFE) rods.

6. The pipette tip disposal guide of claim 4, further comprising a polytetrafluoroethylene (PTFE) coating on the plurality of rods.

7. The pipette disposal guide of claim 4, wherein the elongated body further comprises a floor below the plurality of rods, wherein the rods are spaced apart such that fluid from the pipette tips flows between the rods.

8. The pipette disposal guide of claim 2, wherein a diameter of each of the plurality of rods is between 0.5 mm and 8 mm.

9. The pipette disposal guide of claim 1, wherein the contact-reducing structure of the major surface comprises a lotus effect structure.

10. The pipette disposal guide of claim 1, wherein the major surface comprises an upper portion and a lower portion, wherein a slope angle of the upper portion is greater than a slope angle of the lower portion.

11. An automated liquid handling system comprising a pipette tip disposal guide configured to guide pipette tips to a pipette tip disposal comprising:
a probe with a removable pipette tip configured to collect and expel liquid samples;
a pipette tip disposal configured to receive the pipette tip when the pipette tip is removed from the probe; and
a pipette tip disposal guide configured to guide the pipette tip into the pipette tip disposal, the pipette tip disposal guide comprising:
an elongated body having an upper first end and an opposite, lower second end, and a major surface extending between the first and second ends, the second end being configured to be positioned adjacent the pipette tip disposal for an automated liquid handling system;
wherein the major surface comprises a contact-reducing structure and is configured to receive a pipette tip such that the pipette moves toward the lower second end to the pipette tip disposal with reduced contact with the pipette tip disposal guide.

12. The automated liquid handling system of claim 11, wherein the pipette tip disposal guide further comprises a plurality of rods extending horizontally along the elongated body, wherein the contact-reducing structure of the major surface is provided by top portions of the plurality of rods.

13. The automated liquid handling system of claim 11, wherein the contact-reducing structure is hydrophobic.

14. The automated liquid handling system of claim 12, wherein the pipette tip disposal guide further comprises first and second side walls on an outer side edge of the elongated body between the first and second ends, wherein the plurality of rods are mounted on the first and second side walls.

15. The automated liquid handling system of claim 14, wherein the plurality of rods are polytetrafluoroethylene (PTFE) rods.

16. The automated liquid handling system of claim 14, further comprising a polytetrafluoroethylene (PTFE) coating on the plurality of rods.

17. The automated liquid handling system of claim 14, wherein the elongated body further comprises a floor below the plurality of rods, wherein the rods are spaced apart such that fluid from the pipette tips flows between the rods.

18. The automated liquid handling system of claim 12, wherein a diameter of each of the plurality of rods is between 0.5 mm and 8 mm.

19. The automated liquid handling system of claim 11, wherein the contact-reducing structure of the major surface comprises a lotus effect structure.

20. The automated liquid handling system of claim 11, wherein the major surface comprises an upper portion and a lower portion, wherein a slope angle of the upper portion is greater than a slope angle of the lower portion.

21. A method of disposing of a pipette tip in a pipette tip disposal of an automated liquid handling system, the method comprising:
removing a pipette tip from a probe in an automated liquid handling system and positioning the pipette tip on a pipette tip disposal guide;
guiding the pipette tip into the pipette tip disposal with a pipette tip disposal guide, the pipette tip disposal guide comprising:
an elongated body having an upper first end and an opposite, lower second end, and a major surface extending between the first and second ends, the second end being configured to be positioned adjacent the pipette tip disposal for an automated liquid handling system;
wherein the major surface comprises a contact-reducing structure; and
moving the pipette tip toward the lower second end of the pipette tip disposal guide and into the pipette tip disposal with the pipette tip having reduced contact with the pipette tip disposal guide.
